(19) United States
(12) Patent Application Publication
(10) Pub. No.: US 2010/0120601 A1
(43) Pub. Date: May 13, 2010

(54) MANUFACTURING METHOD OF GLASS MOLDED BODY, MANUFACTURING APPARATUS OF GLASS MOLDED BODY, AND GLASS MOLDED BODY

(76) Inventors: Shunichi Hayamizu, Hyogo (JP); Yoshihiro Kamada, Osaka (JP); Tadashi Sugiyama, Tokyo (JP); Kaoru Serada, Osaka (JP)

Correspondence Address: BRINKS HOFER GILSON & LIONE, P.O. BOX 10395, CHICAGO, IL, 60610, US

(21) Appl. No.: 12/451,453

(22) PCT Filed: May 2, 2008
(86) PCT No.: PCT/JP2008/058414

§ 371 Date: Nov. 12, 2009

(30) Foreign Application Priority Data
May 14, 2007 (JP) 2007-127729

(51) Int. Cl. C03C 3/00; C03B 11/08; G12B 1/00

(52) U.S. Cl. 501/11; 65/29.12; 65/164

(57) ABSTRACT

A process for producing a glass molding, in which a glass molding of stable quality can be efficiently produced through minimizing of temperature fluctuation of molten glass drops at pressure molding operation; and an apparatus for production of a glass molding used in this process. Molten glass drops are fed into an inferior die by causing the molten glass drops to fall from above toward the inferior die. The arrival of molten glass drops having fallen at a given location is detected, and pressurization of the molten glass drops by means of molding dies is initiated upon the passage of a given time since the detection.

### TECHNICAL FIELD

The present invention relates to a manufacturing method of a glass molded body which can be used as various kinds of optical elements, a manufacturing apparatus of a glass molded body and a glass molded body.

### BACKGROUND ART

In recent years, as lenses for digital cameras, optical pickup lenses for DVD, etc., lenses for cameras of mobile phones, coupling lenses for optical communications, and the like, optical elements made of glass are used widely. As such optical elements made of glass, glass molded bodies manufactured by a process of conducting press molding for glass materials with a shaping mold have been used more often.

In the conventional method (hereafter, referred to as “reheat-pressing method”) which has been used widely as a manufacturing method of a glass molded body, a glass material used for manufacturing a molded body is produced preliminary to have a specified weight and shape, and is heated together with a shaping mold to a temperature at which the shape of the glass material becomes changeable, and thereafter the glass material is pressed and shaped by a shaping mold.

According to the reheat-pressing method, since the press shaping can be conducted while controlling the temperature of a glass material or a shaping mold precisely, dispersion in the performance of the manufactured glass molded body can be suppressed to be comparatively small. However, this method needs to repeat heating and cooling a glass molded body and a shaping mold for each shaping shot, and in order to suppress dispersion in temperature at the time of conducting press shaping and to conduct the shaping with sufficient reproducibility, it has a fundamental problem that the shaping for one time takes a very long time.

On the other hand, in a well-know method as another manufacturing method, a shaping mold is heated preliminary to a prescribed temperature, a molten glass droplet is supplied to the surface of the shaping mold, and a press molding is conducted for the supplied molten glass droplet with the shaping mold while the temperature of the molten glass droplet is still a temperature at which the shape of the molten glass droplet is changeable (for example, refer to Patent Document 1). In such a method of conducting press molding for a molten glass droplet, it is not necessary to repeat heating and cooling a shaping mold, etc. and a glass molded body can be manufactured directly from a molten glass droplet. Therefore, a time necessary for conducting a molding process at one time can be shortened so much.

Furthermore, the following method is proposed in order to conduct press molding for a minute molten glass droplet so as to manufacture a minute glass molded body: a molten glass droplet dropped from a nozzle is made to collide with a member provided with a small through hole, and a part of the collided molten glass droplet as a minute droplet is made to pass through the small through hole and is supplied to a lower mold (for example, refer to Patent Document 2).

Patent documents 1: Japanese Patent Unexamined Publication No. 1-308840

Patent documents 2: Japanese Patent Unexamined Publication No. 2002-154834

### DISCLOSURE OF THE INVENTION

### Problem to be Solved by the Invention

The methods described in Patent Documents 1 and 2 are a method of supplying a molten glass droplet to a lower mold by causing the molten glass droplet to drop from a nozzle and conducting press molding. In these methods, when a predetermined amount of molten glass is accumulated at a tip portion of a nozzle, a molten glass drops naturally from the nozzle. Therefore, the dropping intervals can be adjusted to some extent by the heating temperature of the nozzle. However, since the temperature of the nozzle is easily influenced by disturbances, such as temperature in the vicinity of the nozzle and a flow of air, it is difficult to keep the dropping intervals of a molten glass droplet constant perfectly.

In these methods, to a lower mold heated to a predetermined temperature, supplied is a molten glass droplet having a temperature higher than that of the lower mold. Therefore, the supplied molten glass droplet is quickly cooled by heat release from its contact portion with the lower mold. Therefore, when the process is repeated to manufacture many glass shaped-bodies, if dispersion arises in dropping intervals, dispersion is further caused in a period of time after a molten glass droplet has been supplied to a lower mold until the molten glass droplet is subjected to press molding, and the temperature of a molten glass droplet at the time of press molding will vary greatly. As a result, the dispersion in the temperature of the molten glass droplet at the time of press molding is directly linked with dispersion in the quality of a obtained glass molded body.

Moreover, as the volume of a molten glass droplet becomes small, the molten glass droplet supplied to the lower mold is cooled quickly. Therefore, in the case of conducting press molding for a minute droplet produced by the method described in Patent Document 2, dispersion in the temperature of a molten glass droplet at the time of press molding becomes large especially. Therefore, it was difficult to manufacture a glass molded body with stable quality.

The present invention is made in view of the above technical themes, and an object of the present invention is to provide a glass molded body manufacturing method capable of manufacturing a glass molded body with stable quality efficiently by suppressing dispersion in the temperature of a molten glass droplet at the time of press molding to the minimum, to provide a manufacturing apparatus for use in the manufacturing method, and a glass molded body manufactured by the manufacturing method.

### Means for Solving the Problem

In order to solve the above-mentioned theme, the present invention has the following features.

1. In a glass molded body manufacturing method of manufacturing a glass molded body by conducting press molding for a molten glass droplet by using a shaping mold having a lower mold and an upper mold, the glass molded body manufacturing method is characterized by comprising:

a supplying process of causing a molten glass droplet to drop from an upper portion toward the lower mold thereby supplying the molten glass droplet to the lower mold;

a detecting process of detecting that the dropped molten glass droplet has reached a predetermined position; and

a pressing process of starting pressing for the molten glass droplet after a predetermined time has elapsed from the detection in the detection process.

2. The glass molded body manufacturing method described in the item 1 is characterized in that the detecting process is a process of detecting that the dropped molten glass droplet has passed through a predetermined position above the lower mold.

3. The glass molded body manufacturing method described in the item 1 is characterized in that the detecting process is a process of detecting an impulse force generated due to the collision of the molten glass droplet with the lower mold by a weight sensor provided in a lower part of the lower mold.

4. The glass molded body manufacturing method described in any one of the items 1 through 3 is characterized in that the supplying process is a process of causing a molten glass droplet dropped from the above portion to collide with a member provided with a small through hole, causing a part of the collided molten glass droplet to pass through the small through hole, and supplying the part to the lower mold.

5. The glass molded body manufacturing method described in the item 1 is characterized in that the supplying process is a process of causing a molten glass droplet dropped from the above portion to collide with a member provided with a small through hole, causing a part of the collided molten glass droplet to pass through the small through hole, and supplying the part to the lower mold and the detecting process is a process of detecting the molten glass droplet has collided with the member provided with the small through hole.

6. The glass molded body manufacturing method described in any one of the items 1 through 5 is characterized in that when a predetermined time has elapsed from the detection in the detecting process, the pressing of the molten glass droplet has been completed.

7. The glass molded body manufacturing method described in the item 2 is characterized in that the passage of the molten glass droplet through the predetermined position is detected by an optical sensor comprising a light emitting section and a light receiving section to receive the light emitted from the light emitting section.

8. In a glass molded body manufacturing apparatus having a shaping mold having a lower mold and an upper mold and for manufacturing a glass molded body by conducting press molding for a molten glass droplet, the glass molded body manufacturing apparatus is characterized by comprising:

a supplying section for causing a molten glass droplet to drop from an upper portion toward the lower mold thereby supplying the molten glass droplet to the lower mold;

a detecting section for detecting that the dropped molten glass droplet has reached a predetermined position; and

a control section for controlling actions of the shaping mold to start pressing for the molten glass droplet after a predetermined time has elapsed from the detection in the detection process.

9. A glass molded body characterized by being manufactured by the glass molded body manufacturing method described in any one of the items 1 through 7.

### EFFECT OF THE INVENTION

According to the present invention, when a predetermined time has elapsed after detecting that a dropped molten glass droplet has reached a predetermined position, pressing for the molten glass droplet by a shaping mold is stated. Therefore, a period of time after the molten glass droplet has come in contact with the lower mold until press molding is started is maintained constant with high accuracy. Therefore, at the time of manufacturing many glass shaped-bodies repeatedly, even if dispersion arises in dropping intervals, dispersion in the temperature of the molten glass droplet at the time of press molding can be suppressed to the minimum, whereby a glass molded body can be manufactured efficiently with stable quality.

### BRIEF DESCRIPTION OF THE DRAWING

FIG. 1 is a schematic diagram showing a glass molded body manufacturing apparatus 10 used in Embodiment 1.

FIG. 2 is a schematic diagram showing a glass molded body manufacturing apparatus 10 used in Embodiment 1.

FIG. 3 is a flowchart showing a glass molded body manufacturing method in Embodiment 1.

FIG. 4 is a schematic diagram showing a glass molded body manufacturing apparatus 20 used in Embodiment 2.

FIG. 5 is a schematic diagram showing a glass molded body manufacturing apparatus 30 used in Embodiment 3.

FIG. 6 is a flowchart showing a glass molded body manufacturing method in Embodiment 3.

### EXPLANATION OF REFERENCE SYMBOLS

10, 20 and 30 Glass molded body manufacturing apparatus
11 and 31 Lower mold
12 and 32 Upper mold
13 Optical Sensor
13a Light emitting section
13b Light receiving section
14 Controller
15 and 35 Shaping mold
16 Timer
21 Weight Sensor
33 Molten glass droplet
34 Small through hole
36 Member provided with small through hole 34
41 Nozzle
42 Melting Bath
43 Molten glass droplet
P1 Dropping position
P2 Molding position

### BEST MODE FOR CARRYING OUT THE INVENTION

Hereafter, embodiments of the present invention will be explained in detail with reference to drawings.

### Embodiment 1

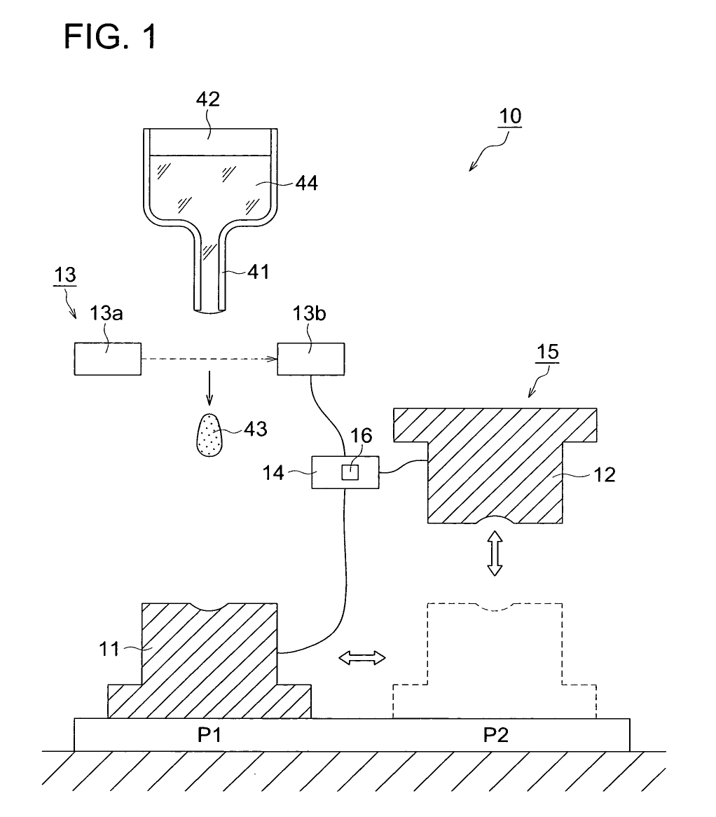

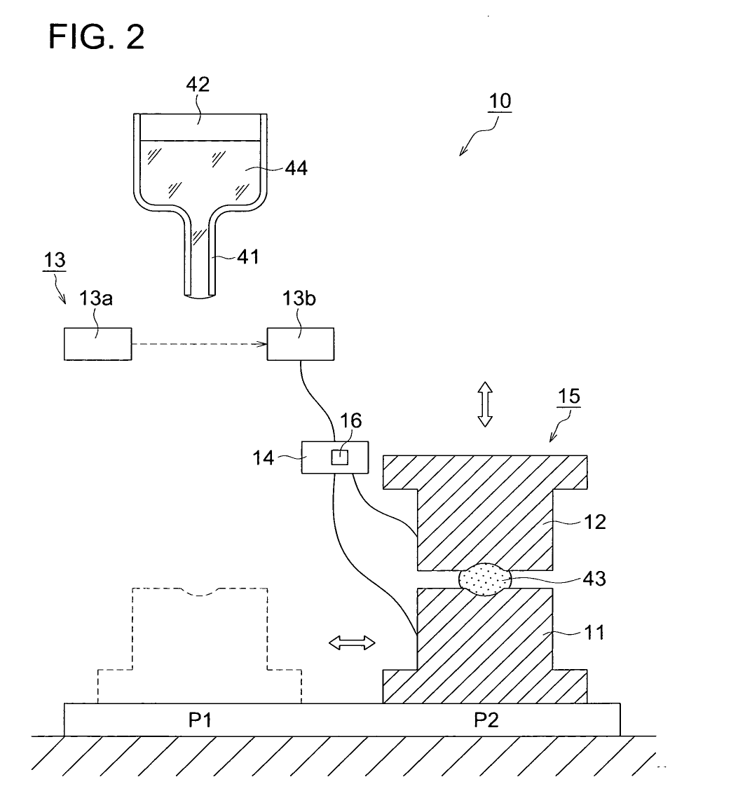

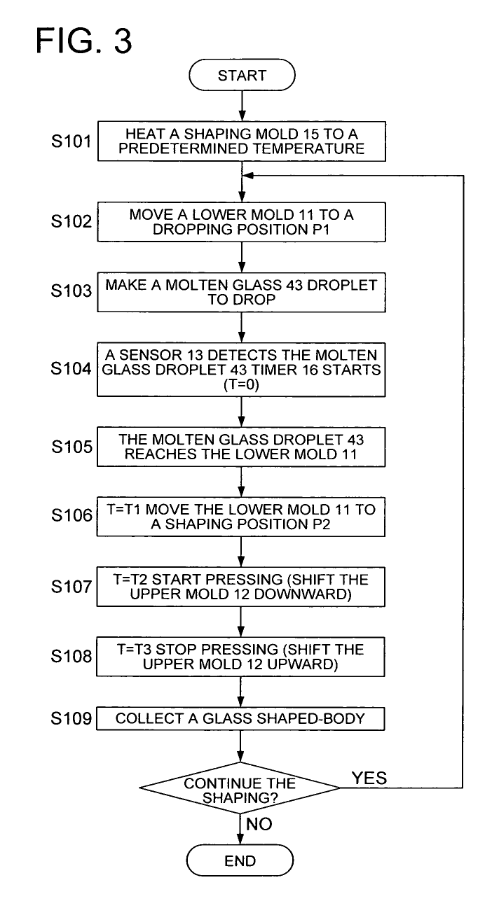

The manufacturing method of a glass molded body according to the first embodiment of the present invention will be explained with reference to FIGS. 1 to 3. FIGS. 1 and 2 are schematic diagrams showing a manufacturing apparatus 10 of a glass molded body, which is used in this embodiment. FIG. 1 shows the state of a supplying process of dropping a molten glass droplet from a nozzle and supplying it to a lower mold, and FIG. 2 shows the state of a pressing process of pressing the supplied molten glass droplet with a shaping mold, respectively. Further, FIG. 3 is a flowchart showing the manufacturing method of a glass molded body in this embodiment.

The manufacturing apparatus 10 of the glass molded body shown in FIGS. 1 and 2 has a shaping mold 15 which includes a lower mold 11 and a upper mold 12 and is used to conduct press molding for a molten glass droplet 43. Further, as a supplying section to supply a molten glass droplet 43 to the lower mold 11, the manufacturing apparatus 10 has a melting bath 42 to store glass 44 in a molten state and a nozzle 41 provided in the lower part of the melting bath 42. The lower mold 11 is structured to be moved by a driving section (not shown) between a position (dropping position P1) beneath a nozzle 41 for receiving a molten glass droplet 43 and a position (shaping position P2) opposite to the upper mold 12 for conducting press molding for a molten glass droplet 43. Also, the upper mold 12 is structured to be moved by a driving section (not shown) in the direction (the vertical direction in the drawing) to press a molten glass droplet between it and the lower molds 11.

Further, the manufacturing apparatus 10 of a glass molded body has an optical sensor 13 as a detecting section to detect the state that a dropped molten glass droplet 43 has arrived at a predetermined position and a controller 14 as a control section to control actions of the shaping mold 15. The optical sensor 13 has a light emitting section 13a and a light receiving section 13b to receive light emitted from the light emitting section 13a. The controller 14 has a timer 16 to measure the time after the optical sensor 13 has detected a molten glass droplet 43.

The material of the shaping mold 15 may be chosen from well-known materials of a shaping mold for manufacturing a glass molded body by conducting press molding and used suitably. Examples of the material of the shaping mold 15 include ultrahard materials containing various heat-resistant alloys (stainless steel, etc.) and tungsten carbide as main components, various ceramics (silicon carbide, silicon nitride, aluminium nitride, etc.), and composite materials containing carbon, and the like. Further, materials in which a protective layer of various metals, ceramics, and carbon is formed on the above materials, are employable.

The shaping mold 15 is structured to be heated to a prescribed temperature by a heating section (not illustrated). In this case, it may be preferable that the lower mold 11 and the upper mold 12 are subjected to a temperature control independently, respectively. As the heating section, well-known heating sections can be chosen and used suitably. For example, the well-known heating sections include a cartridge heater used in such a way that it is embedded in the inside of a member to be heated, a sheet-shaped heater used in such a way that it is brought in contact with the outside of a member to be heated, an infrared heating device, a high-frequency induction heating device, and the like.

Hereafter, each of processes will be explained in the order in accordance with the flowchart shown in FIG. 3.

First, the shaping mold 15 is heated beforehand to a prescribed temperature (Process S101). As the prescribed temperature, appropriately selected is a temperature at which a good transfer surface is formed on a glass molded body by conducting press molding. Generally, when the temperature of the lower mold 11 or the upper mold 12 is too low, it will become difficult to form a good transfer surface on a glass molded body. On the contrary, when temperature is made too high more than needed, there is fear that fusion takes place between a glass droplet and a shaping mold or the life of a shaping mold may become short. Actually, a proper temperature may change depending on various conditions, such as the kind, shape, and size of a glass droplet, the material of a shaping mold, the kind of a protective layer, the shape and size of a glass molded body, and the location of a heater or a temperature sensor. Therefore, it is desirable to obtain the proper temperature experimentally. Usually, it is desirable to set the temperature to about a temperature from (Tg (glass transition point) of a glass droplet−100° C.) to (Tg+100° C.). The heating temperature of the lower mold 11 may be the same with or different from that of the upper mold 12.

Next, the lower mold 11 is moved to the dropping position P1 (Process S102), and a molten glass droplet 43 is dropped from the nozzle 41 (Process S103). At this time, the melting bath 42 is heated by a heater (not illustrated), and glass 44 in the molten state is stored inside the melting bath 42. The nozzle 41 is provided at the lower side of the melting bath 42, and the glass 44 in the molten state passes through a passage provided inside the nozzle 41 with the aid of its own weight and is accumulate at the tip portion of the nozzle 41 with the aid of its surface tension. When a prescribed amount of the molten glass is accumulate at the tip portion of the nozzle 41, a molten glass droplet 43 is separated naturally from the tip portion of the nozzle 41, and then the molten glass droplet 43 with a prescribed amount drops downward. At this time, the molten glass droplet 43 is on the condition that its temperature is higher than that of the shaping mold 15.

Generally, the weight of the dropping molten glass droplet 43 is adjustable by the outside diameter of the tip portion of the nozzle 41. Although such a weight depends on the kind of a molten glass, a molten glass droplet with a weight of 0.1 to 2 g can be made to drop. Further, the dropping intervals of a molten glass droplet can be adjusted by the inside diameter, length, heating temperature and the like of the nozzle 41. Therefore, if these conditions are set appropriately, it is possible to make a molten glass droplet to drop with a predetermined weight at predetermined intervals.

There is no specific restriction in the kind of usable glass, and the well-known kinds of glass can be chosen and used in accordance with usage. For example, optical glasses, such as a phosphoric acid type glass and a lanthanum type glass, and the like may be usable.

After the molten glass droplet 43 has dropped from the nozzle 41, the optical sensor 13 detects that the dropping molten glass droplet 43 has passed through a predetermined position above the lower mold 11 (Process S104). The optical sensor 13 is arranged at a predetermined position above the lower mold 11, and the optical sensor 13 receives light emitted from a light emitting section 13a with a light receiving section 13b and monitors the intensity of the received light. When a molten glass droplet 43 dropped from the nozzle 41 passes through the optical path between the light emitting section 13a and the light receiving section 13b, light expected to reach the light receiving section 13b is blocked by the molten glass droplet 43, and the intensity of light received by the light receiving section 13b becomes lower, whereby it is possible to detect that the dropped molten glass droplet 43 has passed through the predetermined position. The wavelength of the light used for this detection is not limited specifically and the light may be a visible light or an infrared light.

When the passage of the molten glass droplet 43 is detected by the optical sensor 13 and the information of the passage is sent to a controller 14, a timer 16 of the controller 14 will start measuring time. In the following processes, the actions of the shaping mold 15 are controlled on the basis of the time measured by the timer 16. Each of specified times T1, T2 and T3, which are explained below, represents a period of time measured by the timer 16 from the initial time of 0 second at which the optical sensor 13 detected the passage of the molten glass droplet 43.

As the detecting section for detecting that the dropped molten glass droplet 43 has passed through the predetermined position above the lower mold 11, it is not limited to the optical sensor 13 and various well-known sensors can be used. For example, sensors utilizing an electric wave, sound, temperature, etc. are usable. Especially, since an optical sensor has the advantage that its response speed is quick and strong to disturbance, it can be used preferably. Further, in order to prevent detection errors caused by fluctuation of the drop position of a molten glass droplet over time, it is desirable to have a device to adjust the position of the detecting section.

In this embodiment, the detecting section is made to detect that the molten glass droplet 43 has passed through the predetermined position above the lower mold 11. However, since the molten glass droplet 43 is quickly cooled by contacting the lower mold 11, it is most ideal to measure the elapsed time after the time when the molten glass droplet 43 has collided with the lower mold 11 was made 0 second. However, it may be considered that a period of time after the molten glass droplet 43 has passed through the predetermined position until it collides with the lower mold 11 may be almost constant and only negligible dispersion occurs in the period of time. Therefore, as in this embodiment, with the method of measuring the elapsed time after the time when the molten glass droplet 43 has passed through the predetermined position was made 0 second, the period of time after a molten glass droplet has come in contact with a lower mold until press molding is started can be kept constant with high accuracy.

In this way, the detecting process of the present invention is a process of detecting that a molten glass droplet 43 has arrived at a specified position. Here, the specified position may be a position based on which a period of time after a molten glass droplet 43 has come in contact with the lower mold 11 until press molding is started can be kept constant. For example, as the specified position, the detecting section may detect that a molten glass droplet 43 has actually collided with the lower mold 11, or may detect that a dropped molten glass droplet 43 has passed through a predetermined position above the lower mold 11. Also, the detecting section may detect that a molten glass droplet 43 has separated from the tip portion of the nozzle 41 and starts dropping.

After the molten glass droplet 43 has reached the lower mold 11 (Process S105), when the measuring time by a timer 16 has become the predetermined time T1, the lower mold 11 is moved to the shaping position P2 (Process S106). Here, in the present invention, since it is not necessary to manage specifically strictly the specified time T1 for moving the lower mold 11 to the shaping position P2, it is not essential for the specified time T1 to be based on the measuring time by the timer 16.

Subsequently, when the measuring time by the timer 16 has become the specified time T2, the upper mold 12 is moved downward and the application of pressure is started (Process S107). As mentioned above, in the manufacturing method of the present invention, since the molten glass droplet 43 having a temperature higher than a prescribed temperature of the heated lower mold 11 is supplied to the lower mold 11, the supplied molten glass droplet 43 is quickly cooled by heat release from its contact part with the lower mold 11. Therefore, if there is dispersion in the period of time from the supplying of the molten glass droplet 43 to the press molding, the temperature of the molten glass droplet 43 at the time of the press molding will vary greatly, and the various qualities of a obtained glass molded body will be influenced. For example, the core diameter (thickness on the central axis), the accuracy of a transfer surface, the surface roughness of a transfer surface, the index of refraction and the like are influenced.

Among them, the influence to the core diameter is great especially. If the time until press molding is started becomes short, the temperature of the molten glass droplet 43 at the time of the press molding becomes high. Therefore, since the viscosity becomes low, the molten glass droplet 43 becomes difficult to deform, and the core diameter of an obtained glass molded body becomes thin. On the contrary, if the time until press molding is started becomes long, the temperature of the molten glass droplet 43 at the time of the press molding becomes low. Therefore, since the viscosity becomes high, the molten glass droplet 43 becomes difficult to deform, and the core diameter of an obtained glass molded body becomes thick.

Accordingly, in order to manufacture a glass molded body with stable quality by suppressing dispersion in the temperature of a molten glass droplet at the time of press molding to the minimum, it is necessary to make a period of time after a molten glass droplet 43 has been supplied to the lower mold 11 until press molding is started, constant as much as possible. In this embodiment, when a predetermined time T2 has elapsed after the optical sensor 13 detected the passage of a molten glass droplet 43, press molding is started. Accordingly, even if there is dispersion in dropping intervals, dispersion in the temperature of a molten glass droplet 43 at the time of press molding can be suppressed to the minimum. As a result, a glass molded body can be manufactured efficiently with stable quality.

Since a proper time of the predetermined time T2 may changes depending on various conditions, such as the temperature of the lower mold 11, the upper mold 12, nozzle 41 or the like, the kind of glass, the size of a glass molded body, and a core diameter, it is desirable to determine the proper temperature experimentally. Generally, when the predetermined time T2 is set at a time within the range from about one second to several seconds, a glass molded body can be manufactured with stable quality.

During the press molding, the heat of the molten glass droplet 43 is taken from the contact surface of the molten glass droplet 43 with the lower mold 11 or the upper mold 12, and then the cooling of the molten glass droplet 43 is advanced further. When the measuring time by the timer 16 becomes the predetermined time T3, the application of pressure is canceled and the upper mold 12 is moved upward (Process S108). The predetermined time T3 may be set at a time when the molten glass droplet 43 is cooled to the temperature at which the shape of a transfer surface formed on a glass molded body does not collapse even if the application of pressure by the shaping mold 15 is cancelled. Since the influence of the predetermined time T3 on the quality of a glass molded body is not great as compared with the above-mentioned predetermined time T2, the predetermined time T3 is not necessarily required to be determined based on the measuring time by the timer 16. However, in order to manufacture efficiently a glass molded body with more stable quality, it is desirable to determine the predetermined time T3 based on the measuring time by the timer 16. With regard to the temperature at which the shape of a transfer surface does not collapse even if the application of pressure is cancelled, although the temperature may change depending the kind of glass, the size and shape of a glass molded body and a required accuracy, it may be permissible to cool the molten glass droplet 43 to a temperature near the glass transition point Tg of the glass.

The load to be applied onto a molten glass droplet 43 as the application of pressure may be always constant, or may be changed in terms of time. In order to enhance transfer accuracy, it is desirable to apply the load of a predetermined value or more in such a way that the condition that the molten glass droplet 43 and the shaping mold 15 are in close contact with each other can be maintained until the molten glass droplet 43 is cooled to the temperature at which the above-mentioned application of pressure can be canceled. The weight of the load may be appropriately set in accordance with the size, etc. of a glass molded body to be manufactured. There is no specific restriction in the driving section to move the upper mold 12 upward or downward, and well-known drive devices, such as an air cylinder, an oil pressure cylinder, and an electric cylinder using a servo-motor, can be chosen suitably, and can be used as the driving section.

After the upper mold 12 has been moved upward, the formed glass molded body is collected (Process S109), whereby the manufacture of a glass molded body is completed. The collecting of a glass molded body can be conducted by a well-known mold releasing apparatus with the utilization of vacuum absorption, etc., for example. Subsequently, when a glass molded body is manufactured successively, the lower mold 11 is moved again to the dropping positions P1 (Process S102), and the following processes may be repeated.

The manufacturing method of a glass molded body of according to the present invention may include another process in addition to the processes having been explained above. For example, after a glass molded body has been collected at Process 5109, a process of cleaning the shaping mold 15, etc. may be provided additionally.

The glass molded body manufactured by the manufacturing method of the present invention can be used as various optical elements, such as imaging lenses for a digital camera and the like, optical pickup lenses for DVD and the like, and coupling lenses for optical communications. Further, if the glass molded body is further heated, softened and pressed by a shaping mold, various optical elements can also be manufactured from the glass molded body.

### Embodiment 2

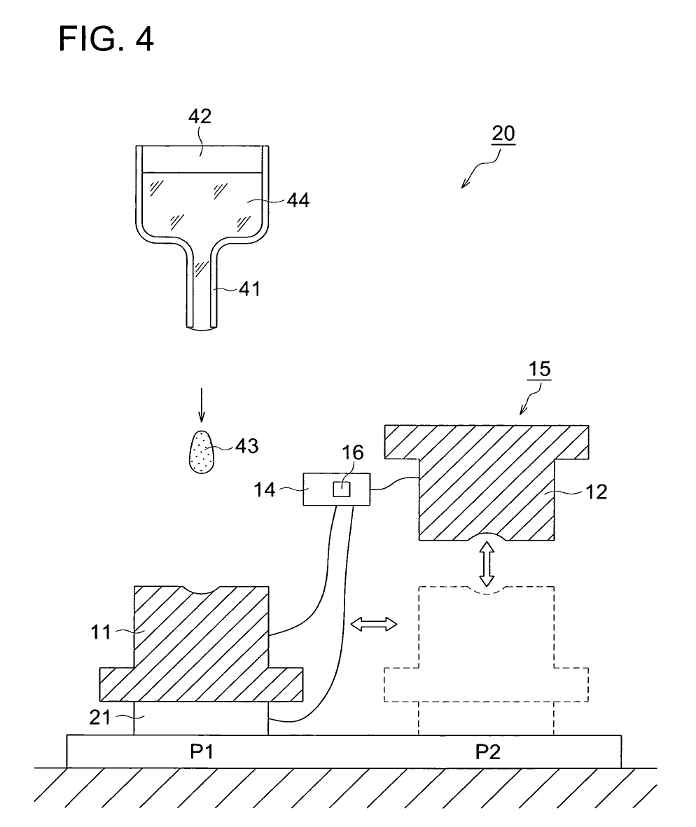

Next, the manufacturing method of a glass molded body as the second embodiment of the present invention will be explained with reference to FIG. 4. FIG. 4 is a schematic diagram showing a manufacturing apparatus 20 of a glass molded body, which is used in the second embodiment, and shows the state of a supplying process of dropping a molten glass droplet 43 from a nozzle 41 and supplying it to a lower mold 11.

The difference of the manufacturing apparatus 20 of a glass molded body from the manufacturing apparatus 10 of a glass molded body in the first embodiment explained previously is in a detecting section for detecting that a dropped molten glass droplet 43 has arrived at a predetermined position. The manufacturing apparatus 20 of a glass molded body shown in FIG. 4 has a weight sensor 21 in the lower part of the lower mold 11. If the weight sensor 21 detects an impulse force generated when a molten glass droplet 43 dropped from the nozzle 41 collides with the lower mold 11, the information about the impulse force is sent to a controller 14, a timer 16 of the controller 14 will be started.

As the weight sensor 21, well-known sensors can be chosen suitably and can be used. For example, a sensor employing a piezoelectric element, a sensor employing a strain gage, etc. are usable. Especially, the sensor employing a piezoelectric element has high sensibility and its response speed is quick. Accordingly, it can be used preferably. The weight sensor 21 may also be provided to the lower part of the lower mold 11 such that it comes in direct contact with the lower mold 11, or it may also be provided such that other members are inserted between it and the lower mold 11. For example, it is desirable to provide a heat insulation member between the lower mold 11 and the weight sensor 21 in such a way that the heat of the lower mold 11 is not transferred directly to the weight sensor 21.

Except that detecting section differ, the processes of manufacturing a glass molded body in this embodiment is the same as the processes in the first embodiment shown in FIG. 3. Therefore, if Process 5101 through Process S109 having been explained previously are conducted sequentially in the order, a glass molded body can be manufactured efficiently with stable quality.

### Embodiment 3

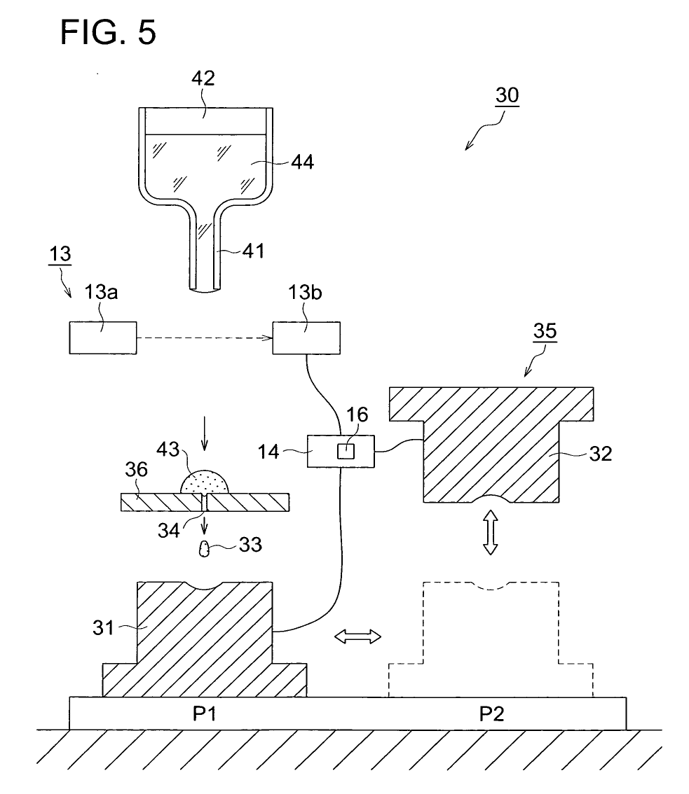

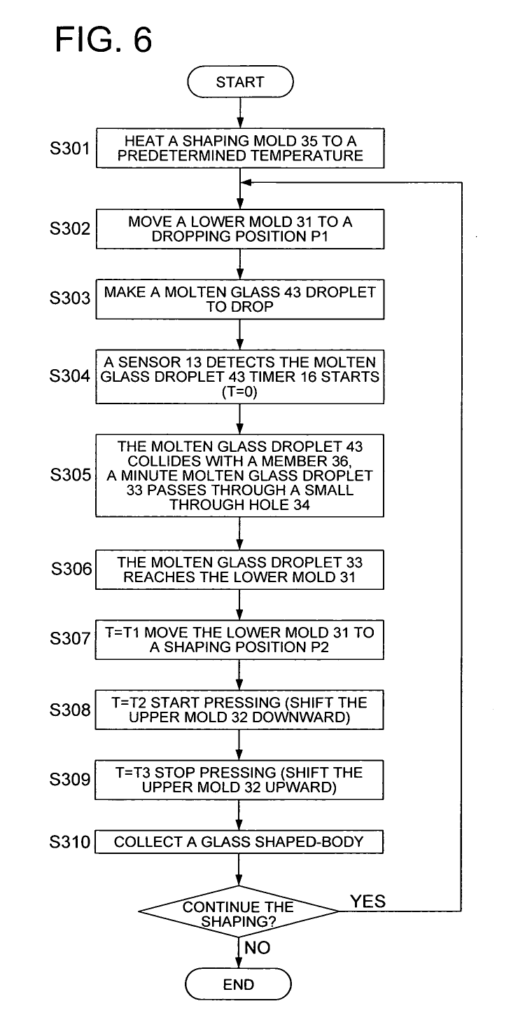

Next, the manufacturing method of a glass molded body as the third embodiment of the present invention will be explained with reference to FIG. 5 and FIG. 6. FIG. 5 is a schematic diagram showing a manufacturing apparatus 30 of a glass molded body, which is used in the third embodiment, and shows the state of a supplying process of dropping a molten glass and supplying it to a lower mold. FIG. 6 is a flowchart showing the manufacturing method of a glass molded body in this embodiment.

The difference of the manufacturing apparatus 30 of a glass molded body from the manufacturing apparatus 10 of a glass molded body in the first embodiment explained previously is in that the manufacturing apparatus 30 has a member 36 provided with a small through hole 34 in order to supply a minute molten glass droplet 33 to a lower mold. Further, a shaping mold 35 includes a lower mold 31 and an upper mold 32 with respective small molding surfaces. Other structures are the same as those of the manufacturing apparatus 10 of a glass molded body.

As with the case of Embodiment 1, a shaping mold 35 is heated beforehand to a predetermined temperature (Process S301), a lower mold 31 is moved to the dropping position P1 (Process S302), and a molten glass droplet 43 is dropped from a nozzle 41 (Process S303). The passage of the molten glass droplet 43 is detected by an optical sensor 13 and the information about the passage is sent to a controller 14, then a timer 16 of the controller 14 will be started (Process S304).

The molten glass droplet 43 collides with the member 36 provided with the small through hole 34, and a part of the molten glass droplet 43 passes the small through hole 34 as a minute molten glass droplet 33 (Process S305) and reaches the lower mold 31 (Process S306).

In this description, the case where the optical sensor 13 detects that the molten glass droplet 43 dropped from the nozzle 41 has passed through a predetermined position is explained as an example. However, the method of detecting a molten glass droplet is not limited to this example. For example, the detecting method includes the following ways: the optical sensor 13 may detect that the molten glass droplet 33 pushed out from the small through hole 34 has passed through a predetermined position, or the weight sensor provided in the lower part of the lower mold 31 may detect an impulse force generated when the molten glass droplet 33 collides with the lower mold. Further, the detecting method may detect impulse force, sound, etc. generated when the molten glass droplet 43 collides with the member 36 provided with the small through hole 34.

The shape of the member 36 provided with the small through hole 34 is not limited specifically. For example, as disclosed in Patent documents 2, a member provided with a tapered surface, or a member having a guide hole, etc. can also be used.

After the molten glass droplet 33 has reached the lower mold 31, a glass molded body is manufactured by the same processes as Embodiment 1. When the measuring time by the timer 16 becomes the predetermined time T1, the lower mold 31 is moved to the shaping position P2 (Process S307), and when the measuring time by the timer 16 becomes the predetermined time T2, the upper mold 32 is moved downward and the application of pressure is started (Process S308). When the volume of the molten glass droplet 33 becomes small, cooling may progress quickly. Therefore, especially in the case that the press molding of a minute molten glass droplet 33 is conducted by the use of the member 36 provided with the small through hole 34 as with this embodiment, the method of the present invention can be used effectively.

When the measuring time by the timer 16 becomes the predetermined time T3, the application of pressure is canceled and the upper mold 32 is moved upward (Process S309). Then, a glass molded body is collected, whereby the manufacture of a glass molded body (process S310) has been completed.

### Example

Hereafter, examples having been conducted to check the effectiveness of the present invention will be described. However, the present invention is not limited to these examples.

### Example 1

A glass molded body was manufactured in accordance with the flowchart shown in FIG. 3 in Embodiment 1 by the use of the manufacturing apparatus 10 of a glass molded body.

A ultrahard material containing tungsten carbide as main components was used as the material of both the lower mold 11 and the upper mold 12. The outside diameter of a glass molded body to be manufactured is set to 7 mm in diameter, and the thickness of a core was set to 3.5 mm as a target value. A phosphoric acid type glass having a glass transition point Tg of 480° C. was used as the glass material. The heating temperature of the shaping mold 15 in Process S101 was set at 500° C. in the lower mold 11 and at 450° C. in the upper mold 12.

The temperature near the tip portion of the nozzle 41 was made 1000° C., and the manufacturing apparatus 10 was set such that about 190 mg of a molten glass droplet 43 dropped at intervals of about 10 seconds. In this condition, 100 drops of molten glass droplets 43 were made to drop for a period of time, and dispersion in the dropping intervals was measured during the period of time. As a result, there was a difference of 0.2 seconds between the longest interval and the shortest interval.

The predetermined time T1 at which the lower mold 11 was moved to the shaping position P2 was set to 3 seconds, the predetermined time T2 for starting press molding was set to 12 seconds, and the predetermined time T3 for ending the press molding was set to 27 seconds, and then 100 glass shaped-bodies were manufactured. The load for press molding was 1800 Ns. The molten glass droplets dropped from the nozzle 41 at intervals of about 10 seconds. Among the dropped molten glass droplets, one droplet per five droplets was used for the manufacture of a glass molded body. Therefore, one glass molded body was manufactured every about 50 seconds.

The thickness of core of each of 100 manufactured glass shaped-bodies was measured. As a result, the difference between the maximum thickness and the minimum thickness was 0.002 mm. Accordingly, it was confirmed that the thickness of core was remarkably stable.

### Comparative Example 1

In Comparative example 1, the optical sensor 13 was not used. Instead, false signals generated once at 50 seconds were sent to the controller 14, and a glass molded body was manufactured by a method of starting a timer 16 in response to the false signals. Other conditions were made to the same as Example 1. The thickness of core of each of 100 manufactured glass shaped-bodies was measured. As a result, the difference between the maximum thickness and the minimum thickness was 0.02 mm. Accordingly, it was confirmed that very large dispersion took place as compared with Example 1.

### Example 2

A glass molded body was manufactured in accordance with the flowchart shown in FIG. 6 in Embodiment 3 by the use of the manufacturing apparatus 30 of a glass molded body.

As the material of both the lower mold 11 and the upper mold 12, silicon nitride was used. The outside diameter of a glass molded body to be manufactured is set to 3.8 mm in diameter, and the thickness of a core was set to 2.6 mm as a target value. A lanthanum type glass having a glass transition point Tg of 640° C. was used as the glass material. The heating temperature of the shaping mold 35 in Process 5301 was set at 580° C. in both the lower mold 31 and the upper mold 32.

The temperature near the tip portion of the nozzle 41 was made 1100° C., and the manufacturing apparatus 30 was set such that about 200 mg of a molten glass droplet 43 dropped at intervals of about 10 seconds. In this condition, 100 drops of molten glass droplets 43 were made to drop for a period of time, and dispersion in the dropping intervals was measured during the period of time. As a result, there was a difference of 0.2 seconds between the longest interval and the shortest interval. In the manufacturing apparatus 30, the diameter of the small through hole 34 was φ 2.3 mm, and the weight of the molten glass droplet 33 having passed through the small through hole 34 was about 60 mg.

The predetermined time T1 at which the lower mold 31 was moved to the shaping position P2 was set to 2 seconds, the predetermined time T2 for starting press molding was set to 6 seconds, and the predetermined time T3 for ending the press molding was set to 15 seconds, and then 100 glass shaped-bodies were manufactured. The load for press molding was 1800 Ns. The molten glass droplets dropped from the nozzle 41 at intervals of about 10 seconds. Among the dropped molten glass droplets, one droplet per three droplets was used for the manufacture of a glass molded body. Therefore, one glass molded body was manufactured every about 30 seconds.

The thickness of core of each of 100 manufactured glass shaped-bodies was measured. As a result, the difference between the maximum thickness and the minimum thickness was less than 0.001 mm. Accordingly, it was confirmed that the thickness of core was remarkably stable.

### Comparative Example 2

In Comparative example 2, the optical sensor 13 was not used. Instead, false signals generated once at 30 seconds were sent to the controller 14, and a glass molded body was manufactured by a method of starting a timer 16 in response to the false signals. Other conditions were made to the same as Example 2. The thickness of core of each of 100 manufactured glass shaped-bodies was measured. As a result, the difference between the maximum thickness and the minimum thickness was 0.04 mm. Accordingly, it was confirmed that very large dispersion took place as compared with Example 2.

1-9. (canceled)

10. A method of manufacturing a glass molded body comprising:
providing a shaping mold having a lower mold and an upper mold;
supplying a molten glass droplet to the lower mold by causing a molten glass droplet to drop from an upper portion toward the lower mold;
detecting that the dropped molten glass droplet has reached a predetermined position; and
pressing the molten glass droplet with the shaping mold after a predetermined time has elapsed from the detecting that the dropped molten glass droplet has reached the predetermined position.

11. The method of claim 10, wherein the detecting that the dropped molten glass droplet has reached the predetermined position comprises detecting that the dropped molten glass droplet has passed a predetermined position above the lower mold.

12. The method of claim 10, wherein the detecting that the dropped molten glass droplet has reached the predetermined position comprises detecting an impulse force generated by collision of the molten glass droplet with the lower mold by a weight sensor provided to the lower mold.

13. The method of claim 10, wherein the supplying the molten glass droplet to the lower mold comprises causing the dropped molten glass droplet to collide with a member provided with a small through-hole, causing a part of the collided molten glass droplet to pass through the small through-hole, and supplying the passed part of the collided molten glass droplet to the lower mold.

14. The method of claim 10, wherein the supplying the molten glass droplet to the lower mold comprises causing the dropped molten glass droplet to collide with a member provided with a small through-hole, causing a part of the collided molten glass droplet to pass through the small through-hole, and supplying the passed part of the collided molten glass droplet to the lower mold, and the detecting that the dropped molten glass droplet has reached the predetermined position comprises detecting that the dropped molten glass droplet has collided with the member provided with the small through-hole.

15. The method of claim 10, wherein when a second predetermined time has elapsed from the detecting that the dropped molten glass droplet has reached the predetermined position, the pressing of the molten glass droplet has been completed.

16. The method of claim 11, wherein the detecting that the dropped molten glass droplet has passed the predetermined position above the lower mold comprises providing an optical sensor comprising a light emitting section and a light receiving section, emitting light from the light emitting section and receiving the light with the light receiving section.

17. A glass molded body manufacturing apparatus for manufacturing a glass molded body, comprising:
a shaping mold having a lower mold and an upper mold configured for press molding a molten glass droplet;
a supplying section adapted to supply a molten glass droplet to the lower mold by causing the molten glass droplet to drop from an upper portion toward the lower mold;
a detecting section adapted to detect that the dropped molten glass droplet has reached a predetermined position; and
a control section operable to control the shaping mold such that the shaping mold starts pressing the molten glass droplet after a predetermined time has elapsed from the detection by the detecting section.

18. A glass molded body manufactured by the method described in claim 10.
